(19) United States
(12) Patent Application Publication
(10) Pub. No.: US 2002/0002821 A1
(43) Pub. Date: Jan. 10, 2002

(54) PHOTONIC ENGINE

(76) Inventor: CEZARY RAFAK GALINSKI, GLIWICE (PL)

Correspondence Address: CEZARY GALINSKI, OBRONCOW POKOJU 113, GLIWICE, 44-100, PL

(21) Appl. No.: 09/477,631

(22) Filed: Jan. 5, 2000

Related U.S. Application Data
(60) Provisional application No. 60/158,914, filed on Oct. 12, 1999.

(51) Int. Cl. F03H 3/00

(52) U.S. Cl. 60/203.1

(57) ABSTRACT

Both chemical and nuclear rocket engines waste huge amounts of energy. This waste can be decreased by application of light-conducting structures.

In case of chemical engine transparent walls of combustion chamber can allow to intercept generated light into light-conducting components. They can deflect photons trajectory in the same direction as a stream of exhaust gases. This can generate additional thrust.

In case of thermonuclear photonic engine typical nuclear engine may be used as a fuel pump. Thermonuclear reaction is initiated in stream of thermonuclear fuel exiting nuclear engine. Light-conducting components intercept photons generated during this reaction. They can deflect photons trajectory in the same direction as a stream of exhaust gases. This can generate additional thrust.

In both cases light-conducting structure is used to decrease loses of energy in typical rocket engines.

Light conducting structure may be used to create antimatter photonic engine as well. In this case the antimatter portions are released into the chamber where they hit the stream of matter what causes annihilation. Light-conducting components intercept photons generated during this reaction. They can deflect photons trajectory in the same direction. This can generate the thrust.

Light-conducting components can be made of optic fibers, but light-conducting surfaces can be used as well. Light conducting surfaces have to meet the following conditions:

Photons generated during reaction enter into the structure according to the rule of complete internal reflection,

Once photons enter the structure they are reflected many times, but always according to the rule of complete internal reflection,

Curvature should assure correct flow direction after photons exit the structure.

Light-conducting surfaces can help to organize flow of the coolant around hot regions of the engine.

Application of light-conducting components to generate thrust of the engine is disclosed, as well as the shape of light-conducting components useful in this application, and cooling system that allows to keep safe temperature inside light-conducting components and recover additional amount of energy.

### CROSS REFERENCE

A typical rocket engine bums chemical fuel in the combustion chamber. Temperature and pressure increase force exhaust gases to exit the engine threw a nozzle. Gases momentum is equal to rocket momentum with the opposite sign, that propels the rocket.

Nuclear rocket engine contains nuclear reactor that is cooled by hydrogen flowing across. Hydrogen temperature and pressure are rising. Finally hot hydrogen exits the engine threw a nozzle and propels the rocket.

In both cases there is a significant waste of energy that could be decreased.

In case of chemical engine walls of the combustion chamber are not transparent. Radiation caused by the flame is absorbed by walls and wasted.

Energy dissipated by this radiation could be utilized if deflected in the same direction as exhaust gases. This could be obtained by application of transparent, and properly shaped walls. This technique should be useful in case of fuel/oxidizer combinations that does not create nontransparent products e.g. hydrogen/oxygen.

In case of nuclear engine not all potential of hydrogen is used. Laser beams directed into one region in hydrogen (or other nuclear engine coolant) stream could initiate thermonuclear reaction. Once again correct deflection of the radiation generated, could substantially increase the thrust of the engine.

### BACKGROUND

Light is a type of the electromagnetic radiation. It can be generated during glowing, chemical burning, nuclear and thermonuclear reactions etc. It spreads around thanks to photons. Photons are the particles that have zero motionless weight. However when flowing with light speed they have a momentum. Photon's momentum could generate significant thrust if directed in one direction.

Light can be deflected by reflection in the mirror or by internal reflection by the bound between transparent media with different densities. Typical mirror absorbs large amounts of energy. So it would be destroyed if applied to reflect radiation from high-energy source. Second type of reflection is applied in optic fibers. Experience shows, that loses of energy in optic fibers are extremely low. This should allow creating more effective type of the “mirror”.

### BRIEF SUMMARY

Photonic engine contains “fuel pump”, chamber with nozzle, ignition mechanism and light-conducting structure. Fuel of any type is injected into the chamber. Ignition system initiates reaction that sets free the energy trapped in the fuel. Exhaust gases exit the chamber threw the nozzle. Initially photons generated during reaction are spreaded equally in all directions. Then they are intercepted by transparent light-conducting structure. They are reflected many times by the structure's bounds and their trajectory becomes curved. Finally most of photons are flowing approximately in the same direction as the stream of exhaust gases. This allows to increase thrust and efficiency of the engine.

### BRIEF DESCRIPTION DRAWINGS

FIG. 1 General configuration of the chemical photonic engine.

This drawing shows arrangement of chemical engine elements. Entrances of the fuel and the oxidizer, combustion chamber, exhaust nozzle are presented as well as light conducting structure arrangement, cooling medium entrance and exit.

FIG. 2 General configuration of the thermonuclear photonic engine.

This drawing shows arrangement of thermonuclear engine elements. Entrance of thermonuclear fuel is presented as well as light conducting structure arrangement, point of thermonuclear reaction, cooling medium entrance and exit.

FIG. 3 General configuration of the antimatter photonic engine.

This drawing shows arrangement of antimatter engine elements. Entrances of matter and antimatter are presented as well as light conducting structure arrangement, region of highly probable annihilation, cooling medium entrance and exit.

FIG. 4 Rules of reflection at the entrance to light-conducting structure and coolant stream.

This drawing shows how photons are reflected by bounds between light conducting components of the structure and coolant in different regions of the engine.

### DETAILED DESCRIPTION OF THE INVENTION

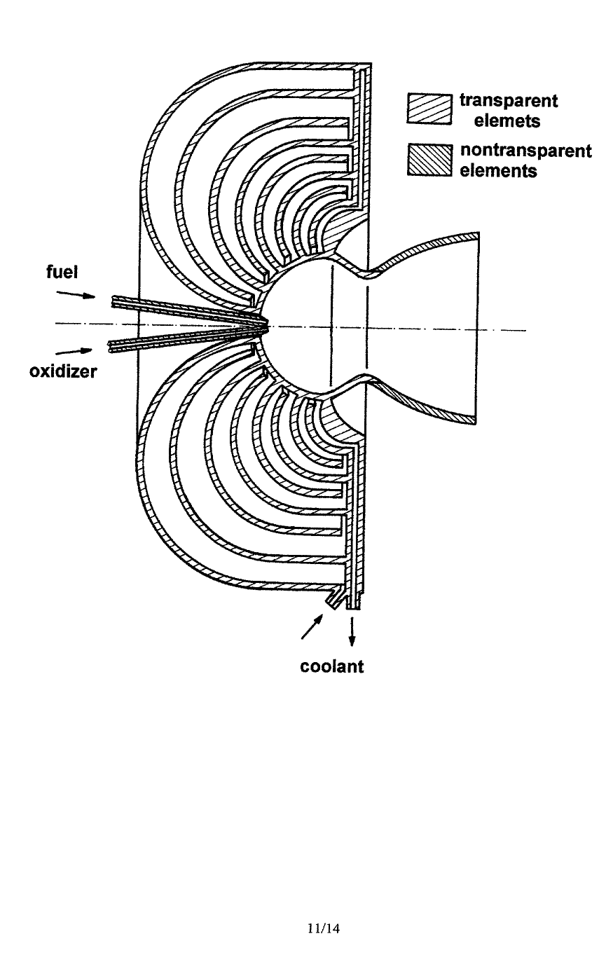

Chemical photonic engine (FIG. 1) contains fuel pump, oxidizer pump, combustion chamber, nozzle, ignition mechanism, light-conducting structure and cooling system. Fuel and oxidizer are injected into the chamber. Ignition system initiates combustion. Exhaust gases exit the chamber through the nozzle. Combustion takes place in whole volume of the chamber. Photons generated during reaction are spreaded equally in all directions. Light-conducting components are configured in this way that photons enter them according to the rule of complete internal reflection. Then photons are reflected many times by the bounds of light-conducting components and photons trajectory becomes curved. Finally most of photons are flowing approximately in the same direction as the stream of exhaust gases. This allows to increase thrust and efficiency of the engine.

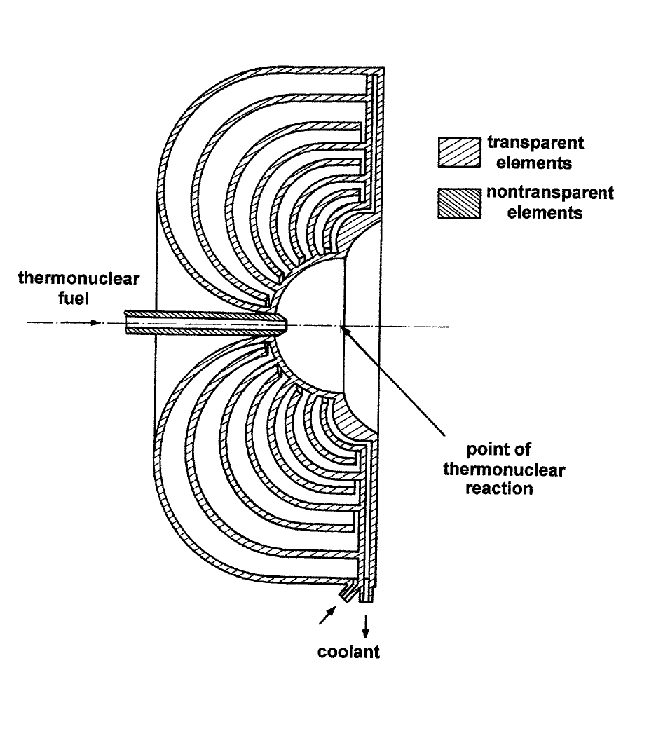

Thermonuclear photonic engine (FIG. 2) contains nuclear engine or other type of thermonuclear fuel provider, light-conducting structure, ignition system and cooling system. Hydrogen or Helium are the examples of thermonuclear fuel. Thermonuclear fuel exiting nuclear engine threw the nozzle enters the chamber built of light-conducting components. Ignition system consists of lasers directed into the one point in the stream of thermonuclear fuel. Ignition is conducted by activation of lasers. Their beams cross each other in one point of the thermonuclear fuel stream, so this point has enough energy to initiate thermonuclear reaction. Stream of the thermonuclear fuel has to be fast enough or it can be quantified in strictly specified portions to keep this reaction in the same point. Photons generated during this reaction can flow in all directions with the same probability. Light-conducting components are configured in this way that photons enter them according to the rule of complete internal reflection. Then photons are reflected many times by the bounds of light-conducting components and their trajectory becomes curved. Finally most of photons are flowing approximately in the same direction as the stream of exhaust gases. This allows to increase thrust and efficiency of the engine.

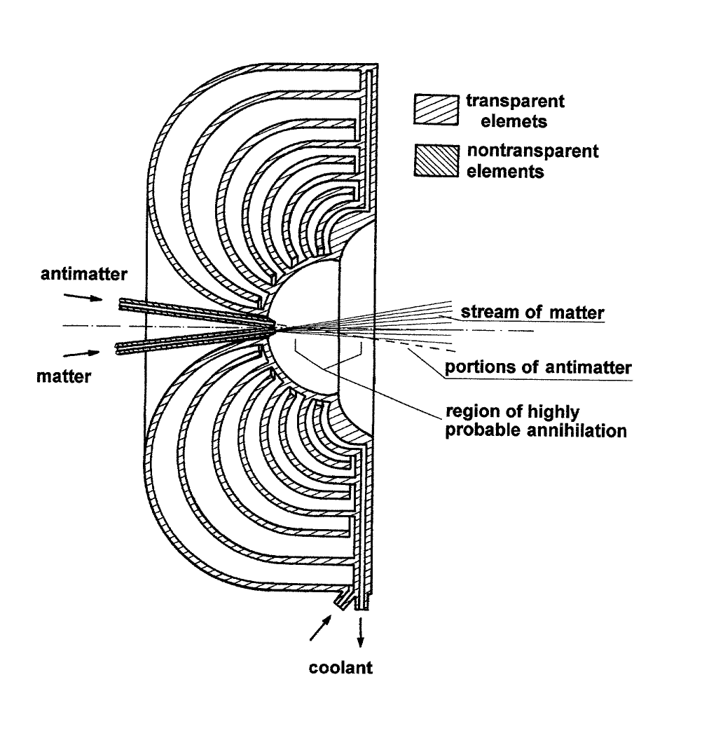

Antimatter photonic engine (FIG. 3) contains matter tank and pump, antimatter trap, annihilation chamber, light-conducting structure and cooling system. Protons and antiprotons are the examples of matter and antimatter. The stream of matter is injected into the chamber. Occasionally portions of antimatter are released from trap into the chamber. Antimatter's trajectory crosses matter's stream. When a particle of matter hits a particle of antimatter, annihilation occurs. Photons generated during this reaction can flow in all directions with the same probability. Light-conducting components are configured in this way that photons enter them according to the rule of complete internal reflection. Then photons are reflected many times by the bounds of light-conducting components and their trajectory becomes curved. Finally most of photons are flowing approximately in the same direction as the stream of exhaust gases. This allows to generate thrust of the engine.

Typical optic fibers can be used to manufacture light-conducting structure. But it is believed that they will absorb some amount of energy. So if high-energy source is applied temperature of the structure could be dangerous. That is why some kind of cooling system should be applied.

The following is the better solution of the cooling problem. Light-conducting structure consists of solid transparent surfaces shaped according to all of the following conditions:

Photons generated during reaction enter into the structure according to the rule of complete internal reflection

Once photons enter the structure they are reflected many times, but always according to the rule of complete internal reflection,

Curvature should assure correct flow direction after photons exit the structure.

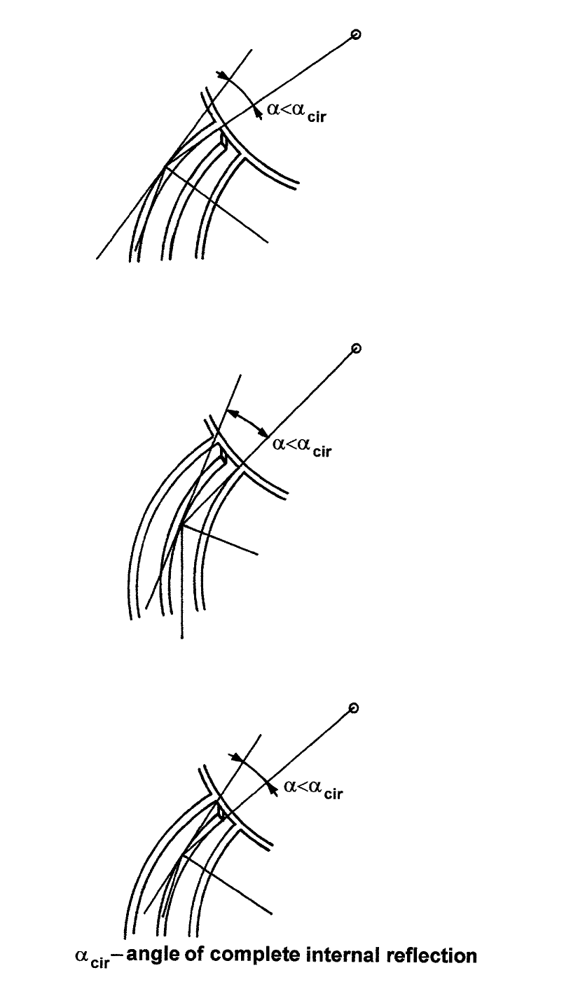

Idea of the light conducting structure made of transparent surfaces is presented on FIG. 1-3. Photon's entrance conditions are presented on the FIG. 4.

Between the surfaces empty spaces exist. Lightweight liquid coolant flows in between some of these spaces. Coolant flows out from remaining spaces.

Spaces are connected to allow free flow of the coolant between them, along the whole surface of the structure:

Hot coolant can be used to propel the turbines in cooling process. So additional portion of energy can be recovered and used in spacecraft systems.

1. Application of light-conducting components (including optic fibers, light conducting surfaces, etc.) to deflect photons generated in engine to receive thrust.

2. Application of light-conducting structure, consisting of solid transparent surfaces that meet the following conditions:
Photons generated during reaction enter into the structure according to the rule of complete internal reflection,
Once photons enter the structure they are reflected many times, but always according to the rule of complete internal reflection,
Curvature should assure correct flow direction after photons exit the structure,
to deflect photons generated in the engine to receive thrust.

3. Application of the cooling system consisting of the coolant flowing between light conducting surfaces for propulsion applications.
